(19) United States
(12) Patent Application Publication
(10) Pub. No.: US 2006/0108779 A1
(43) Pub. Date: May 25, 2006

(54) Vehicle steering wheel with a gas bag module and a discharge opening

(75) Inventors: Markus Keutz, Rossdorf (DE); Matthias Helmstetter, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/283,741

(22) Filed: Nov. 21, 2005

(30) Foreign Application Priority Data
Nov. 22, 2004 (DE) 20 2004 018 121.5

(51) Int. Cl. B60R 21/203; B60R 21/26

(52) U.S. Cl. 280/731; 280/740; 280/742

(57) ABSTRACT

A vehicle steering wheel includes a gas bag module which has a gas generator (14) for filling a gas bag. The steering wheel has at least one discharge opening (12; 34) formed in a rigid component (10) of the steering wheel or of the gas bag module, through which opening gas generated by the gas generator (14) can partially discharge. The steering wheel further includes at least one electrically controllable closure element (14; 26; 28), by which the discharge opening (12; 34) can be opened. The closure element (14; 26, 28) is designed and controllable such that it is movable several times into an open position and into a closure position.

### TECHNICAL FIELD

The invention relates to a vehicle steering wheel including a gas bag module.

### BACKGROUND OF THE INVENTION

In European Patent Application EP 1 279 574 A1 a vehicle steering wheel with a gas bag module is shown, which has several discharge openings in a retainer. The discharge openings can be opened or not depending on the determined severity of the accident. Upon opening, a slider is displaced so that bores formed therein come into alignment with the discharge openings. The hot gas flowing into the gas bag melts the region of the gas bag situated between the bores of the slider and the discharge openings in the retainer, so that a portion of the gas emerges out from the gas bag.

From U.S. Pat. No. 6,547,274 a vehicle steering wheel including a gas bag module which has a gas generator for filling a gas bag is known. At least one discharge opening is formed in a rigid component of the gas bag module, through which opening the gas generated by the gas generator can partially flow off. The steering wheel further includes an electrically controllable closure element by which the discharge opening can be opened. On filling of the gas bag, the cross-section of the discharge opening in a support plate can be opened by means of a control valve. The control valve comprises several flaps which can be bent by means of piezoelectric elements. The current supply of the piezoelectric elements is controlled, for example, depending on the posture or the physique of the vehicle occupant or on the speed of the vehicle.

In the known systems, a decision is made as to whether discharge openings are opened or not. Further measures for adjusting the outflowing quantity of gas are not provided.

It is an object of the invention to enable a discharge behaviour which is better adjustable both during the filling of the gas bag and also during a subsequent plunging of the vehicle occupant into the gas bag.

### BRIEF SUMMARY OF THE INVENTION

The vehicle steering wheel according to the invention includes a gas bag module which has a gas generator for filling a gas bag. The steering wheel has at least one discharge opening formed in a rigid component of the steering wheel or of the gas bag module, through which opening gas generated by the gas generator can partially discharge. The steering wheel further includes at least one electrically controllable closure element, by which the discharge opening can be opened. The closure element is designed and controllable so that it is movable several times into an open position and into a closure position. The invention therefore permits a continuous adjustment of the discharge behaviour. Especially during the phase of filling of the gas bag and during the phase of plunging of the vehicle occupant, the opening cross-section can be varied so that optimum restraint characteristics can be achieved with different loads on the gas bag.

### BRIEF DESCRIPTION OF THE DRAWINGS

FIG. 1 shows a detail of a steering wheel according a first embodiment of the invention in perspective view; and

FIG. 2 shows a detail of a steering wheel according a second embodiment of the invention in perspective view.

### DETAILED DESCRIPTION OF THE PREFERRED EMBODIMENTS

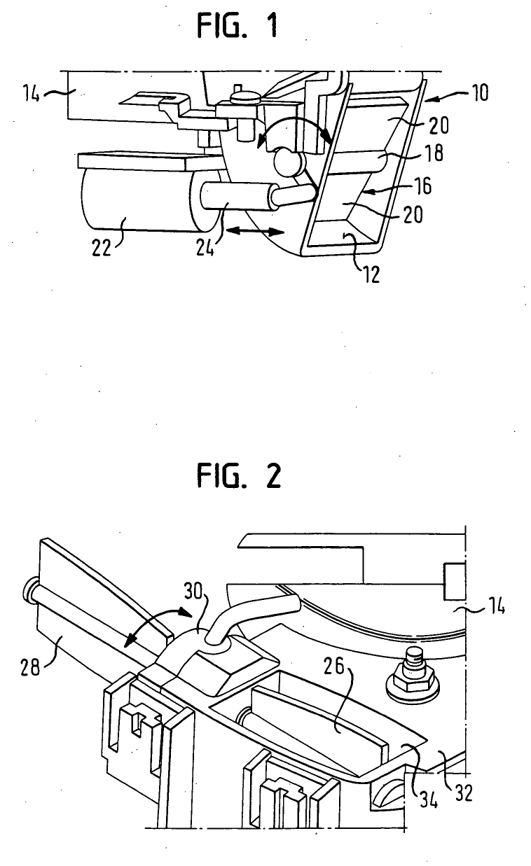

FIG. 1 shows part of a steering wheel including a gas bag module which is not illustrated in detail. In a rigid component 10 of the steering wheel, a discharge opening 12 is formed, through which a portion of the gas provided by a gas generator 14 can be led off. The discharge opening 12 is able to be closed by means of a closure element in the form of a rotatably mounted flap 16. The flap 16 has an axis 18 and two wings 20 extending from the axis 18. The flap 16 is coupled to a drive unit 22 with a linearly displaceable drive element 24 (the coupling is only illustrated symbolically). The flap 16 can be moved by the drive unit 22 with the drive element 24 between a closure position, in which the discharge opening 12 is substantially closed, and an open position, in which the discharge opening 12 is opened.

The controlling of the drive unit 22 allows the flap 16 to be moved (toggled) several times between the open and closure positions. The flap 16 can also assume intermediate positions (several times), so that the discharge opening 12 is only partially opened. In this way, the quantity of outflowing gas can be adjusted over a longer period of time.

In the embodiment shown in FIG. 2, two flaps 26, 28 are actuated with only one drive unit 30. The structure and mounting of the flaps 26, 28 correspond substantially to those of the previously described embodiment. The flaps 26, 28 are associated with two discharge openings, of which only one, namely a discharge opening 34 formed in a gas generator carrier 32 of the gas bag module, is illustrated.

The drive unit 30 in this case is an electric or electromagnetic actuator (e.g. an electromotor or an electromagnetic drive), which can turn the two rotatably mounted flaps 26, 28. The controlling of the drive unit 30 and the possible positions of the flaps 26, 28 correspond to those of the first embodiment.

In all the embodiments, the closure element can also be coupled to the drive unit via a transmission unit.

1. A vehicle steering wheel, including a gas bag module which has a gas generator for filling a gas bag, the steering wheel having at least one discharge opening formed in a rigid component of one of the steering wheel or the gas bag module, through which opening gas generated by the gas generator can partially discharge, the steering wheel further including at least one electrically controllable closure element, by which the discharge opening can be opened, the closure element being designed and controllable such that it is movable several times into an open position and into a closure position.

2. The vehicle steering wheel according to claim 1, wherein the closure element is movable several times into one intermediate position between the open position and the closure position.

3. The vehicle steering wheel according to claim 1, wherein the closure element is movable several times into various intermediate positions between the open position and the closure position.

4. The vehicle steering wheel according to claim 1, wherein the closure element is rotatably mounted.

5. The vehicle steering wheel according to claim 4, wherein the closure element has at least one wing extending from an axis.

6. The vehicle steering wheel according to claim 1, wherein the closure element is coupled to a drive unit accommodated in the steering wheel.

7. The vehicle steering wheel according to claim 6, wherein the drive unit comprises a linearly displaceable drive element.

8. The vehicle steering wheel according to claim 6, wherein the drive unit is an electric or electromagnetic actuator.

9. The vehicle steering wheel according to claim 6, wherein several closure elements are coupled to the drive unit.

10. The vehicle steering wheel according to claim 6, wherein the closure element is coupled to the drive unit via a transmission unit.
